(19) United States
(12) Patent Application Publication
(10) Pub. No.: US 2026/0361132 A1
(43) Pub. Date: Nov. 12, 2026

(54) POLY-PHASE INDUCTIVE POWER TRANSFER APPARATUS TECHNICAL FIELD

(71) Applicant: BorgWarner Inc., Auburn Hills, MI (US)

(72) Inventors: Ken Ray Defore, Commerce Twp., MI (US); Joshua Clint Garrett, Oak Park, MI (US); Frederick Michael Huscher, Hendersonville, NC (US); Gabriel Domingues, Lund (SE)

(21) Appl. No.: 19/204,802

(22) Filed: May 12, 2025

(51) Int. Cl. H02J 50/10; B60L 53/122; H01F 27/28

(52) U.S. Cl. CPC H02J 50/10; B60L 53/122; H01F 27/28

(57) ABSTRACT

A poly-phase inductive power transfer apparatus includes a poly-phase coil assembly including a first coil, a second coil, and a third coil each configured to transmit and/or receive a respective phase of AC power. The poly-phase inductive power transfer apparatus also includes a first lead coupled to the first coil, a second lead coupled to the second coil, and a third lead coupled to the third coil. The first lead defines a first length, the second lead defines a second length, and the third lead defines a third length. The first length, the second length, and the third length are substantially equal to reduce electromagnetic imbalance between the first coil, the second coil, and the third coil.

### TECHNICAL FIELD

The present disclosure relates generally to a poly-phase inductive power transfer apparatus for wireless charging batteries of electrified vehicles.

### BACKGROUND

The automotive industry increasingly seeks to incorporate wireless charging systems into electrified vehicles (such as plug-in hybrids and pure electric vehicles) for several reasons including convenience and potential for automation (e.g. to charge an electrified vehicle without a human plugging in an electrical connector). For high-power/high-speed wireless charging applications, there is a trend toward employing poly-phase (e.g. three-phase) inductive power transfer apparatuses to facilitate high-power/high-speed wireless charging (e.g. 150 kW+). However, there are challenges associated with ensuring that these poly-phase inductive power transfer apparatuses are electromagnetically balanced to ensure maximum wireless charging efficiency. Namely, structural differences between coils and/or leads of these poly-phase inductive power transfer apparatuses may induce electromagnetic imbalance, thereby degrading wireless charging efficiency. To this end, there remains a need for an improved poly-phase inductive power transfer apparatus.

### SUMMARY AND ADVANTAGES

One general aspect of the present disclosure is directed to a poly-phase inductive power transfer apparatus. The poly-phase inductive power transfer apparatus includes a poly-phase coil assembly defining a central axis. The poly-phase coil assembly includes a first coil for transmitting and/or receiving a first phase of AC power. The first coil includes a first connection point for coupling the first coil to a power electronics unit. The poly-phase coil assembly also includes a second coil for transmitting and/or receiving a second phase of AC power. The second coil includes a second connection point for coupling the second coil to the power electronics unit. The poly-phase coil assembly further includes a third coil for transmitting and/or receiving a third phase of AC power. The third coil includes a third connection point for coupling the third coil to the power electronics unit. The poly-phase inductive power transfer apparatus also includes a first lead. The first lead extends between a first connection end coupled to the first coil at the first connection point and a first coupling end opposite the first connection end and configured to be coupled to the power electronics unit. The first lead defines a first length between the first connection end and the first coupling end. The poly-phase inductive power transfer apparatus further includes a second lead. The second lead extends between a second connection end coupled to the second coil at the second connection point and a second coupling end opposite the second connection end and configured to be coupled to the power electronics unit. The second lead defines a second length between the second connection end and the second coupling end. The poly-phase inductive power transfer apparatus additionally includes a third lead. The third lead extends between a third connection end coupled to the third coil at the third connection point and a third coupling end opposite the third connection end and configured to be coupled to the power electronics unit. The third lead defines a third length between the third connection end and the third coupling end. The first length, the second length, and the third length are substantially equal to reduce electromagnetic imbalance between the first coil, the second coil, and the third coil.

Advantageously, the reduced electromagnetic imbalance between the first coil, the second coil, and the third coil by virtue of the first length, the second length, and the third length being substantially equal promotes more efficient wireless transfer power by the poly-phase inductive power transfer apparatus.

### BRIEF DESCRIPTION OF THE DRAWINGS

Other advantages of the present disclosure will be readily appreciated, as the same becomes better understood by reference to the following detailed description when considered in connection with the accompanying drawings.

FIG. 1 is a schematic representation of one configuration of a wireless power transfer system including a poly-phase inductive power transfer apparatus according to the present disclosure.

FIG. 2A is a schematic representation of one configuration of poly-phase inductive power transfer apparatus according to the present disclosure.

FIG. 2B is a schematic representation of another configuration of poly-phase inductive power transfer apparatus according to the present disclosure.

FIG. 3 is a top schematic representation of one configuration of the poly-phase inductive power transfer apparatus.

FIG. 4A is a top perspective schematic representation of one configuration of a coil of the poly-phase inductive power transfer apparatus.

FIG. 4B is a bottom perspective schematic representation of the coil of FIG. 4A.

FIG. 5 is a top schematic representation of another configuration of the poly-phase inductive power transfer apparatus.

FIG. 6 is an enlarged schematic representation of the poly-phase inductive power transfer apparatus of FIG. 5.

FIG. 7 is a cross-sectional schematic representation of the poly-phase inductive power transfer apparatus taken along line 7-7 of FIG. 6.

FIG. 8 is a schematic representation of another configuration of a wireless power transfer system including a poly-phase inductive power transfer apparatus according to the present disclosure.

FIG. 9 is a top schematic representation of the poly-phase inductive power transfer apparatus of FIG. 8.

FIG. 10 is an exploded perspective representation of the poly-phase inductive power transfer apparatus of FIG. 8.

### DETAILED DESCRIPTION

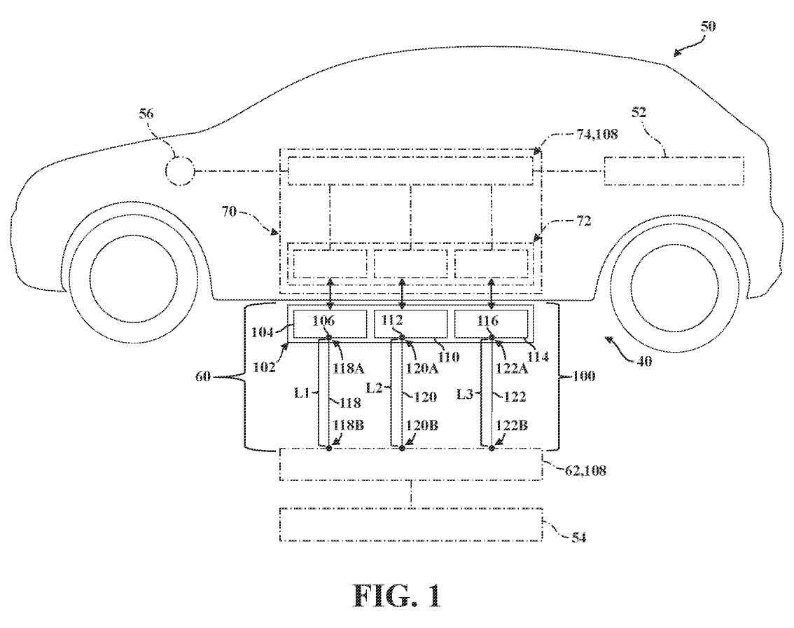

With reference to the Figures, wherein like numerals indicate like parts throughout the several views, FIGS. 1-10 show various examples of a poly-phase inductive power transfer apparatus 100 according to the present disclosure and a wireless power transfer system 40 for charging a battery 52 of an electrified vehicle 50.

FIG. 1 schematically illustrates one example of the wireless power transfer system 40 for charging a battery 52 of an electrified vehicle 50. The wireless power transfer system 40 generally includes a facility wireless charging assembly 60 which is installed in a charging location (e.g. a home, business, charging station, etc.) and a vehicle wireless charging assembly 70 supported within the vehicle 50 which is configured to be aligned with the facility wireless charging assembly 60 to facilitate wireless power transfer therebetween. In some examples, the facility wireless charging assembly 60 may be disposed on a ground/floor surface, and the vehicle wireless charging assembly 70 may be disposed on an underside of the vehicle 50 such that the vehicle 50 may be parked over the facility wireless charging assembly 60 to align the vehicle wireless charging assembly 70 with the facility wireless charging assembly 60 to facilitate wireless power transfer therebetween. In other examples, the facility wireless charging assembly 60 may be disposed on a vertical surface (such as a wall or the like), and the vehicle wireless charging assembly 70 may be disposed within, for example, a front or rear bumper of the vehicle 50 such that the vehicle 50 may be parked relative to the facility wireless charging assembly 60 to align the vehicle wireless charging assembly 70 with the facility wireless charging assembly 60 to facilitate wireless power transfer therebetween. Other configurations for aligning the facility wireless charging assembly 60 with the vehicle wireless charging assembly 70 to facilitate wireless power transfer therebetween are contemplated.

The poly-phase inductive power transfer apparatus 100 according to the present disclosure may be implemented within the facility wireless charging assembly 60 and/or within the vehicle wireless charging assembly 70 to facilitate wireless power transfer therebetween. Stated differently, in some configurations, the poly-phase inductive power transfer apparatus 100 according to the present disclosure is implemented only within the facility wireless charging assembly 60, and the vehicle wireless charging assembly 70 includes a corresponding poly-phase inductive power transfer apparatus 72 having a different configuration. In other configurations, the poly-phase inductive power transfer apparatus 100 according to the present disclosure is implemented only within the vehicle wireless charging assembly 70, and the facility wireless charging assembly 60 includes a corresponding poly-phase inductive power transfer apparatus having a different configuration. In still further configurations, both the facility wireless charging assembly 60 and the vehicle wireless charging assembly 70 include respective poly-phase inductive power transfer apparatuses 100 according to the present disclosure.

FIG. 1 schematically depicts a poly-phase inductive power transfer apparatus 100 according to the present disclosure incorporated within the facility wireless charging assembly 60. FIG. 1 further schematically depicts the vehicle 50 including the vehicle wireless charging assembly 70 with a corresponding poly-phase inductive power transfer apparatus 72 configured to be aligned with and electromagnetically interact with the poly-phase inductive power transfer apparatus 100 incorporated within the facility wireless charging assembly 60 to facilitate wireless power transfer therebetween. As described above, the corresponding poly-phase inductive power transfer apparatus 72 of the vehicle wireless charging assembly 70 may have the same configuration as the poly-phase inductive power transfer apparatus 100 of the facility wireless charging assembly 60, but in other configurations the corresponding poly-phase inductive power transfer apparatus 72 of the vehicle wireless charging assembly 70 may have a different configuration.

In some examples, wireless power transfer between the facility wireless charging assembly 60 and the vehicle wireless charging assembly 70 is unidirectional such that the facility wireless charging assembly 60 only transfers power to the vehicle wireless charging assembly 70. However, in other configurations, wireless power transfer between the facility wireless charging assembly 60 and the vehicle wireless charging assembly 70 is bidirectional such that the facility wireless charging assembly 60 is configured to transfer power to the vehicle wireless charging assembly 70 in a charging mode, and vehicle wireless charging assembly 70 is configured to transfer power to the facility wireless charging assembly 60 in a vehicle to grid (V2G) mode.

The facility wireless charging assembly 60 includes a facility power electronics unit 62 configured to be coupled to an external power source 54 to receive AC power from the external power source 54 (e.g. from a power grid). For high-power, fast charging applications (i.e., Level 3 charging), the AC power provided by the external power source 54 is typically three-phase AC power supplied at 400-480 volts and at currents as high as 500 amps or more. For lower-power charging applications (i.e., Level 2 charging), the AC power provided by the external power source 54 is typically single-phase AC power supplied at 200-240 volts and at currents as high as 60 amps or more. The AC power provided by the external power source 54 is typically low-frequency AC power (e.g. 50-60 Hz). The facility power electronics unit 62 is configured to convert the AC power provided by the external power source 54 into a format suitable for the poly-phase inductive power transfer apparatus 100 to wirelessly transfer power to corresponding poly-phase inductive power transfer apparatus 72 of the vehicle wireless charging assembly 70. Typically, the AC power transferred between the poly-phase inductive power transfer apparatus 100 and the corresponding poly-phase inductive power transfer apparatus 72 is high-frequency AC power (e.g. 85 kHz). Where the wireless power transfer between the facility wireless charging assembly 60 and the vehicle wireless charging assembly 70 is bidirectional, the facility power electronics unit 62 may also be configured to convert power received by the facility wireless charging assembly 60 from the vehicle wireless charging assembly 70 into a format suitable for return to the external power source 54.

The facility power electronics unit 62 may include various power electronics components known in the art to convert the low-frequency AC power from the external power source 54 to high-frequency AC power suitable for the poly-phase inductive power transfer apparatus 100 to wirelessly transfer power to corresponding poly-phase inductive power transfer apparatus 72 of the vehicle wireless charging assembly 70 (and vice-versa where the wireless power transfer between the facility wireless charging assembly 60 and the vehicle wireless charging assembly 70 is bidirectional). For example, the facility power electronics unit 62 may include rectifier circuits, inverter circuits, transformers, the like, and combinations thereof. Other configurations of the facility power electronics unit 62 are contemplated.

The vehicle wireless charging assembly 70 also includes a vehicle power electronics unit 74. The vehicle power electronics unit 74 is configured to convert the power received by the corresponding poly-phase inductive power transfer apparatus 72 into a format suitable for charging the battery 52 of the vehicle 50. Typically, power is supplied to the battery 52 of the vehicle 50 as DC power having a voltage of from 400-800 volts. Where the wireless power transfer between the facility wireless charging assembly 60 and the vehicle wireless charging assembly 70 is bidirectional, the vehicle power electronics unit 74 may also be configured to convert power provided by the battery 52 of the vehicle 50 into a format suitable for wireless power transfer to the facility wireless charging assembly 60 (i.e., high-frequency AC power). In some examples, the vehicle 50 also includes a charging port 56 coupled to the vehicle power electronics unit 74 and configured to be conductively coupled to a wired charger to receive AC or DC power from the charger to charge the battery 52 of the vehicle 50.

The vehicle power electronics unit 74 may include various power electronics components known in the art to convert the high-frequency AC power from the vehicle’s poly-phase inductive power transfer apparatus 72 to DC power suitable for charging the battery 52 of the vehicle 50 (and vice-versa where the wireless power transfer between the facility wireless charging assembly 60 and the vehicle wireless charging assembly 70 is bidirectional). For example, the vehicle power electronics unit 74 may include rectifier circuits, inverter circuits, transformers, the like, and combinations thereof. Exemplary configurations of a vehicle power electronics unit 74 configured to accept wired or wireless charge are disclosed in U.S. Patent App. No. 18/676,666, filed May. 29, 2024, the content of which is herein incorporated by reference in its entirety. Other configurations of the vehicle power electronics unit 74 are contemplated.

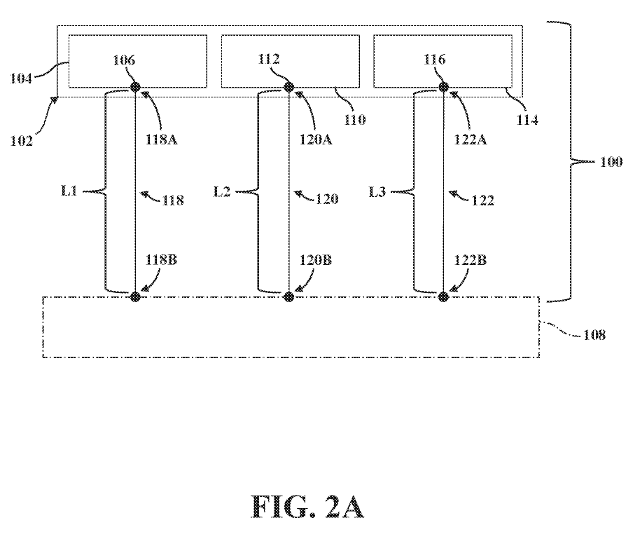

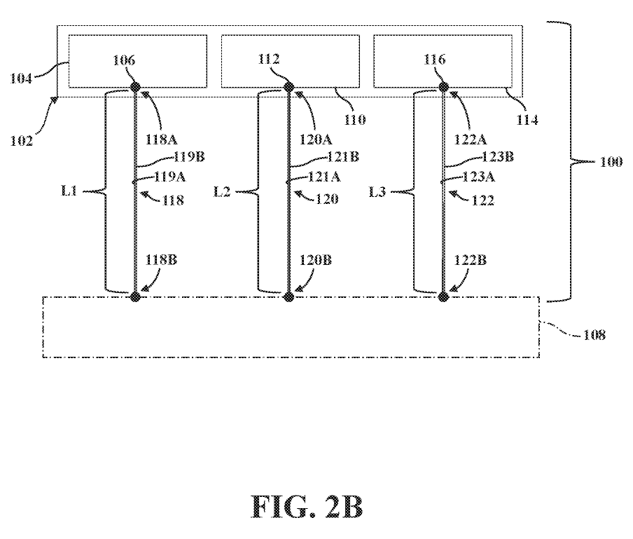

Referring to FIGS. 1-2B, the poly-phase inductive power transfer apparatus 100 includes a poly-phase coil assembly 102 defining a central axis CA. Typically, the poly-phase coil assembly 102 is configured to inductively transmit and/or receive at least three phases of AC power. The poly-phase coil assembly 102 includes a first coil 104 for transmitting and/or receiving a first phase of AC power. The first coil 104 includes a first connection point 106 for coupling the first coil 104 to a power electronics unit 108 (e.g. the facility power electronics unit 62 where the poly-phase inductive power transfer apparatus 100 is incorporated within the facility wireless charging assembly 60, as illustrated, and/or the vehicle power electronics unit 74 where the poly-phase inductive power transfer apparatus 100 is incorporated within the vehicle wireless charging assembly 70). The poly-phase coil assembly 102 also includes a second coil 110 for transmitting and/or receiving a second phase of AC power. The second coil 110 includes a second connection point 112 for coupling the second coil 110 to the power electronics unit 108. The poly-phase coil assembly 102 further includes a third coil 114 for transmitting and/or receiving a third phase of AC power. The third coil 114 includes a third connection point 116 for coupling the third coil 114 to the power electronics unit 108. Exemplary configurations of the first coil 104, the second coil 110, and the third coil 114 are described in further detail below. In some configurations, the poly-phase coil assembly 102 may also be configured to inductively transmit and/or receive a single phase of AC power (e.g. by energizing only one of the first coil 104, the second coil 110, and the third coil 114).

Still referring to FIGS. 1-2B, the poly-phase inductive power transfer apparatus 100 also includes a first lead 118. The first lead 118 extends between a first connection end 118A and a first coupling end 118B opposite the first connection end 118A. The first connection end 118A of the first lead 118 is coupled to the first coil 104 at the first connection point 106. For example, the first connection end 118A of the first lead 118 may be soldered or otherwise electrically coupled to the first connection point 106 of the first coil 104. The first coupling end 118B of the first lead 118 is configured to be coupled to the power electronics unit 108 such that the first lead 118 arranges the power electronics unit 108 in electrical communication with the first coil 104. The first lead 118 defines a first length L1 between the first connection end 118A and the first coupling end 118B.

The poly-phase inductive power transfer apparatus 100 further includes a second lead 120. The second lead 120 extends between a second connection end 120A and a second coupling end 120B opposite the second connection end 120A. The second connection end 120A of the second lead 120 is coupled to the second coil 110 at the second connection point 112. The second coupling end 120B of the second lead 120 is configured to be coupled to the power electronics unit 108 such that the second lead 120 arranges the power electronics unit 108 in electrical communication with the second coil 110. The second lead 120 defines a second length L2 between the second connection end 120A and the second coupling end 120B.

The poly-phase inductive power transfer apparatus 100 additionally includes a third lead 122. The third lead 122 extends between a third connection end 122A and a third coupling end 122B opposite the third connection end 122A. The third connection end 122A of the third lead 122 is coupled to the third coil 114 at the third connection point 116. The third coupling end 122B of the third lead 122 is configured to be coupled to the power electronics unit 108 such that the third lead 122 arranges the power electronics unit 108 in electrical communication with the third coil 114. The third lead 122 defines a third length L3 between the third connection end 122A and the third coupling end 122B.

The first lead 118, the second lead 120, and the third lead 122 may have any suitable structure to conduct high-frequency AC power. As illustrated schematically in FIGS. 1-2B, the first length L1 of the first lead 118, the second length L2 of the second lead 120, and the third length L3 of the third lead 122 are substantially equal to reduce electromagnetic imbalance between the first coil 104, the second coil 110, and the third coil 114 when the first coil 104, the second coil 110, and the third coil 114 are energized. As alluded to above, uneven lengths of the first lead 118, the second lead 120, and the third lead 122 may lead to suboptimal performance of the poly-phase inductive power transfer apparatus 100. Specifically, uneven lengths of the first lead 118, the second lead 120, and the third lead 122 may lead to electromagnetic imbalance between the first coil 104, the second coil 110, and the third coil 114, thereby reducing the efficiency of wireless power transfer by the poly-phase inductive power transfer apparatus 100. For example, uneven lengths of the first lead 118, the second lead 120, and the third lead 122 may lead to situations where the voltage and/or current applied to the first coil 104, the second coil 110, and the third coil 114 differs materially, and thus the first coil 104, the second coil 110, and the third coil 114 are energized differently, thereby reducing the efficiency of wireless power transfer by the poly-phase inductive power transfer apparatus 100. Accordingly, by requiring that the first length L1 of the first lead 118, the second length L2 of the second lead 120, and the third length L3 of the third lead 122 are substantially equal, the poly-phase inductive power transfer apparatus 100 advantageously eliminates such electromagnetic imbalance issues. As used herein, the phrase “substantially equal” refers to the first length L1, the second length L2, and the third length L3 each being within 3% or less of each other, within 2% or less of each other, within 1% or less of each other, within 0.5% or less of each other, within 0.25% or less of each other, etc.

In some examples, such as schematically depicted in FIG. 2A, the first lead 118, the second lead 120, and the third lead 122 each include a single lead wire. Here, the first coil 104, the second coil 110, and the third coil 114 may be electrically coupled to each other (e.g. in a delta or wye configuration) such that the single lead wire of each of the first lead 118, the second lead 120, and the third lead 122 are sufficient to couple the poly-phase coil assembly 102 to the power electronics unit 108 to facilitate wireless power transfer by the poly-phase coil assembly 102. However, in other examples, such as schematically depicted in FIG. 2B, the first lead 118 includes a first pair of lead wires 119A,119B coupled to the first coil 104 and configured to be coupled to the power electronics unit 108, the second lead 120 includes a second pair of lead wires 121A,121B coupled to the second coil 110 and configured to be coupled to the power electronics unit 108, and the third lead 122 includes a third pair of lead wires 123A,123B coupled to the third coil 114 and configured to be coupled to the power electronics unit 108. Here, the first coil 104, the second coil 110, and the third coil 114 are not necessarily electrically coupled to each other (i.e., the first coil 104, the second coil 110, and the third coil 114 may be electromagnetically independent from each other) and, accordingly, implementing each of the first lead 118, the second lead 120, and the third lead 122 as a pair of lead wires facilitates wireless power transfer by the poly-phase coil assembly 102. In these examples, the first connection point 106 of the first coil 104, the second connection point 112 of the second coil 110, and the third connection point 116 of the third coil 114 may each be configured to be coupled to the first pair of lead wires 119A,119B, the second pair of lead wires 121A,121B, and the third pair of lead wires 123A,123B, respectively (e.g. by defining a respective pair of terminals). Other configurations of the first lead 118, the second lead 120, and the third lead 122 are contemplated.

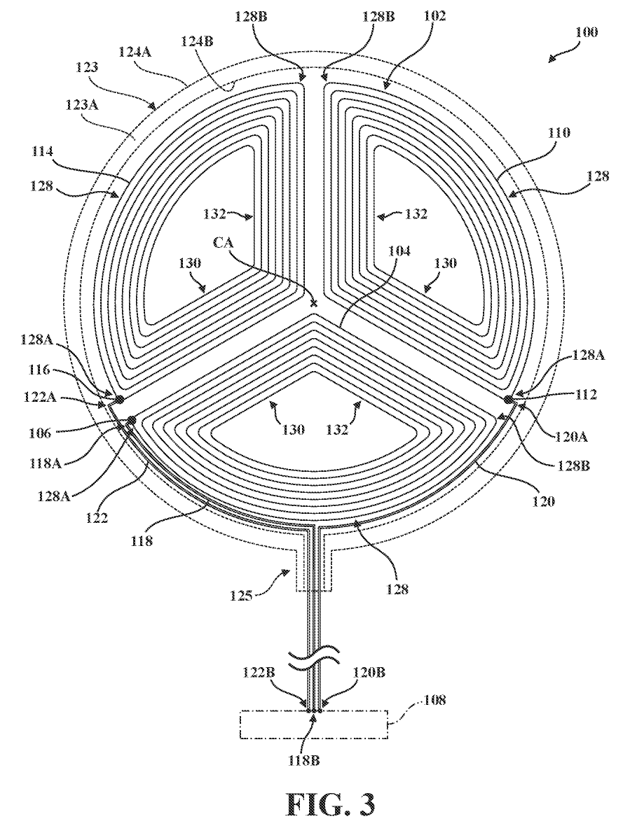

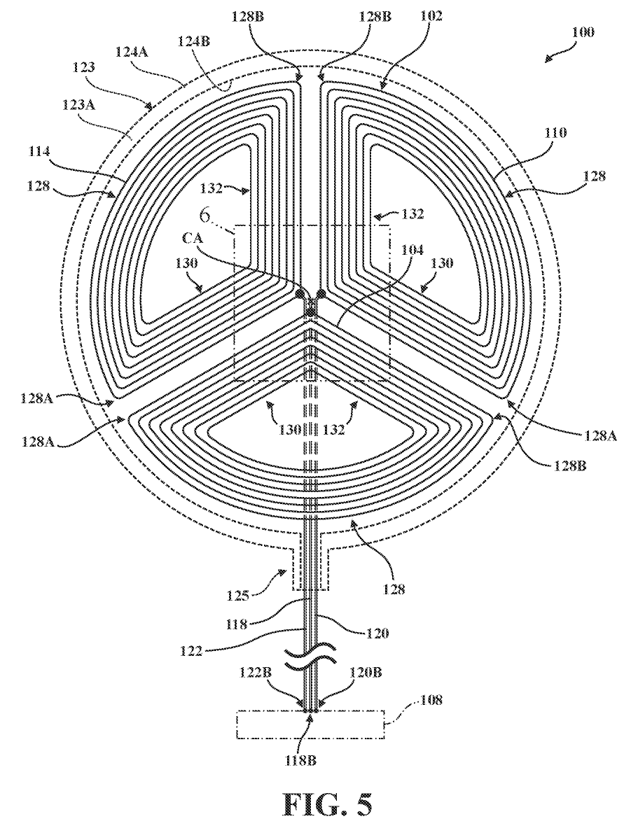

FIGS. 3 and 5 schematically illustrate exemplary configurations of the poly-phase inductive power transfer apparatus 100. As illustrated in phantom in FIGS. 3 and 5, the poly-phase inductive power transfer apparatus 100 may include a housing 123. The housing 123 includes a housing body 124. The housing body 124 defines a housing exterior 124A and a housing interior 124B within which the poly-phase coil assembly 102 is disposed. The housing interior 124B may be a cylindrical housing interior 124B concentric with the central axis CA. Each of the first lead 118, second lead 120, and third lead 122 may extend from the housing interior 124B to the housing exterior 124A to route each of the first lead 118, second lead 120, and third lead 122 between the poly-phase coil assembly 102 and the power electronics unit 108. For example, as illustrated schematically in FIGS. 3 and 5, the housing 123 may define a connection port 125 through which each of the first lead 118, second lead 120, and third lead 122 are disposed to connect the poly-phase coil assembly 102 to the power electronics unit 108. Other configurations of the housing 123 are contemplated.

With continued reference to FIGS. 3 and 5, in some configurations, the poly-phase coil assembly 102 defines a generally circular shape surrounding the central axis CA. In these configurations, the first coil 104 may occupy a first sector 124B-1 of the cylindrical housing interior 124B, the second coil 110 may occupy a second sector 124B-2 of the cylindrical housing interior 124B, and the third coil 114 may occupy a third sector 124B-3 of the cylindrical housing interior 124B. Here, the first sector 124B-1, the second sector 124B-2, and the third sector 124B-3 are equal angular sectors of the cylindrical housing interior 124B. As used herein, the term “sector” refers to a portion of a circle bounded by two radial legs and an arc of the circle. Stated differently, the first coil 104, the second coil 110, and the third coil 114 may each define an approximately third-of-a-circle shape which are evenly distributed about the central axis CA.

In the configuration of FIGS. 3 and 5, each of the first coil 104, the second coil 110, and the third coil 114 include an arc portion 128 extending circumferentially about the central axis CA between a first arc end 128A and a second arc end 128B, a first radial portion 130 extending radially inward from the first arc end 128A toward the central axis CA, and a second radial portion 132 extending radially inward from the second arc end 128B toward the central axis CA. In the configurations of FIGS. 3 and 5, each of the first coil 104, the second coil 110, and the third coil 114 are typically coplanar with a first plane P1. Other configurations of the first coil 104, the second coil 110, and the third coil 114 are contemplated.

Referring to FIG. 3, the first connection point 106 of the first coil 104 may be arranged at one of the first arc end 128A and the second arc end 128B of the first coil 104, the second connection point 112 of the second coil 110 may be arranged at one of the first arc end 128A and the second arc end 128B of the second coil 110, and the third connection point 116 of the third coil 114 may be arranged at one of the first arc end 128A and the second arc end 128B of the third coil 114. In these configurations, as shown in FIG. 3, the first connection point 106 of the first coil 104, the second connection point 112 of the second coil 110, and the third connection point 116 of the third coil 114 are each arranged adjacent to an inner diameter of the cylindrical housing interior 124B and spaced substantially equally from the connection port 125 of the housing 123 such that the first lead 118, the second lead 120, and the third lead 122 extend substantially equal lengths within the housing 123. This configuration allows the overall length of each of the first lead 118, the second lead 120, and the third lead 122 to be substantially equal, thereby reducing electromagnetic imbalance between the first coil 104, the second coil 110, and the third coil 114.

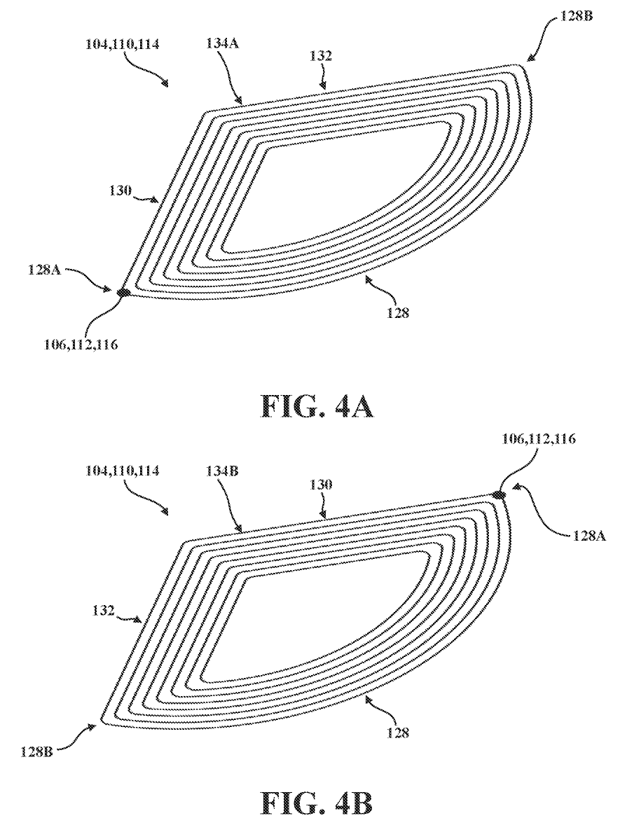

In some examples, each of the first coil 104, the second coil 110, and the third coil 114 have identical structure. Stated differently, each of the first coil 104, the second coil 110, and the third coil 114 may be formed to have the same geometry for ease of manufacturing (e.g. economies of scale, common tooling, etc.). FIG. 4A is a schematic top perspective view and FIG. 4B is a schematic bottom perspective view of one exemplary coil 104, 110, 114 according to the present disclosure having such common/identical structure. Referring to FIGS. 4A and 4B, the coil(s) 104, 110, 114 may each define a first major face 134A (shown in FIG. 4A), and a second major face 134A (shown in FIG. 4B) opposite the first major face 134A.

Referring back to FIG. 3, in order to employ the coil(s) 104, 110, 114 having identical structure within the poly-phase inductive power transfer apparatus 100 configuration illustrated in FIG. 3 (where the respective connection points 106, 112, 116 of the coils 104, 110, 114 are disposed at one of the arc ends 128A, 128B), the first major face 134A of the first coil 104 and the second coil 110 faces a first axial direction along the central axis CA (e.g. away from the page as illustrated in FIG. 3), and the second major face 134B of the third coil 114 faces the first axial direction along said central axis CA. Stated differently, in the configuration of FIG. 3, the first coil 104 and the second coil 110 are disposed upward and the third coil 114 is disposed downward such that the first connection point 106 of the first coil 104, the second connection point 112 of the second coil 110, and the third connection point 116 of the third coil 114 are spaced substantially equally from the connection port 125 of the housing 123. In the configuration of FIG. 5, as described in further detail below, the first coil 104, the second coil 110, and the third coil 114 may be disposed in the same orientation. Other configurations of implementing the first coil 104, the second coil 110, and the third coil 114 to have identical structure are contemplated.

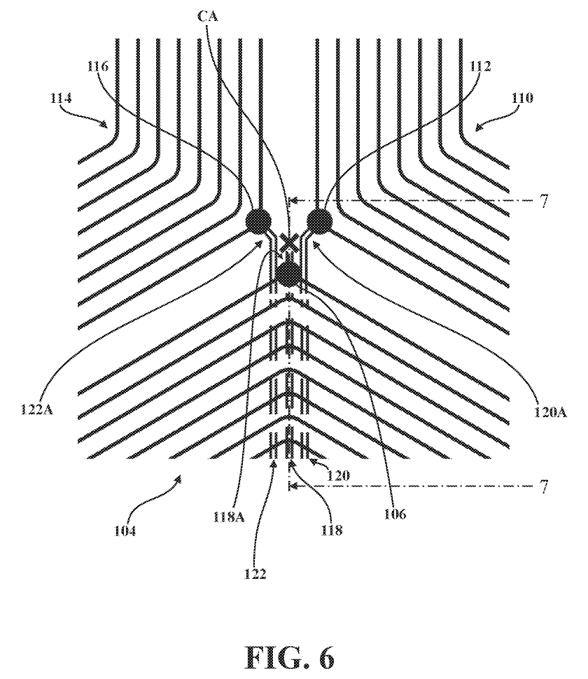

In some examples, each of the first connection point 106 of the first coil 104, the second connection point 112 of the second coil 110, and the third connection point 116 of the third coil 114 are equally radially spaced from said central axis CA. In one example, referring to FIGS. 5 and 6, the first connection point 106, the second connection point 112, and the third connection point 116 are each respectively arranged at the intersection of the first radial portion 130 and the second radial portion 132 of each coil 104, 110, 114, but other configurations are contemplated. In the configuration illustrated in FIGS. 5 and 6, each of the first lead 118, the second lead 120, and the third lead 122 are each initially routed radially inward from respectively the first connection point 106, the second connection point 112, and the third connection point 116 toward the central axis CA and then are routed toward the power electronics unit 108.

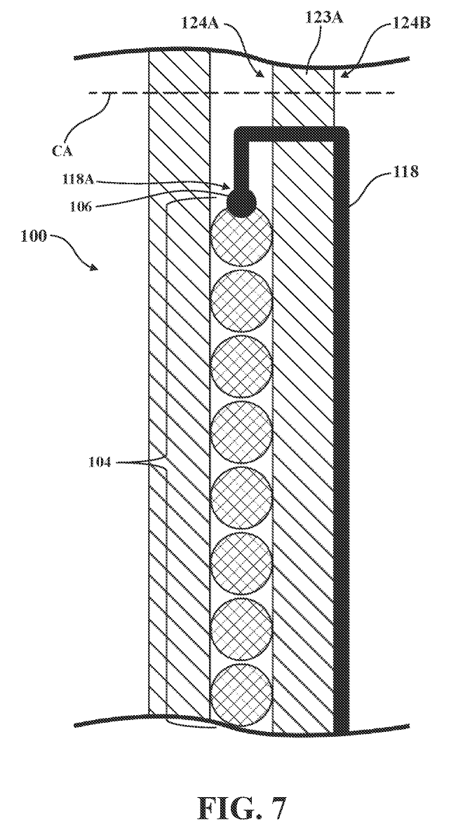

Using the first coil 104 and the first lead 118 as an illustrative example, as best shown in FIG. 7 (which is a schematic cross-sectional representation of the poly-phase inductive power transfer apparatus 100 along line 7-7 of FIG. 6), the first lead 118 may be routed initially within the housing interior 124B from the first connection point 106 of the first coil 104 towards the central axis CA. From here, the first lead 118 may be routed from the housing interior 124B to the housing exterior 124A (e.g., through a port 125 defined by the housing body 123A or a cover member coupled to the housing) such that the first lead 118 is configured to be coupled to the power electronics unit 108. Of course, it should be appreciated that configurations similar to as described herein in the context of the first coil 104 and the first lead 118 may be implemented for the second coil 110 and the second lead 120 as well as the third coil 114 and the third lead 122. Other configurations of routing the first lead 118, the second lead 120, and the third lead 122 from the poly-phase coil assembly 102 to the power electronics unit 108 are contemplated.

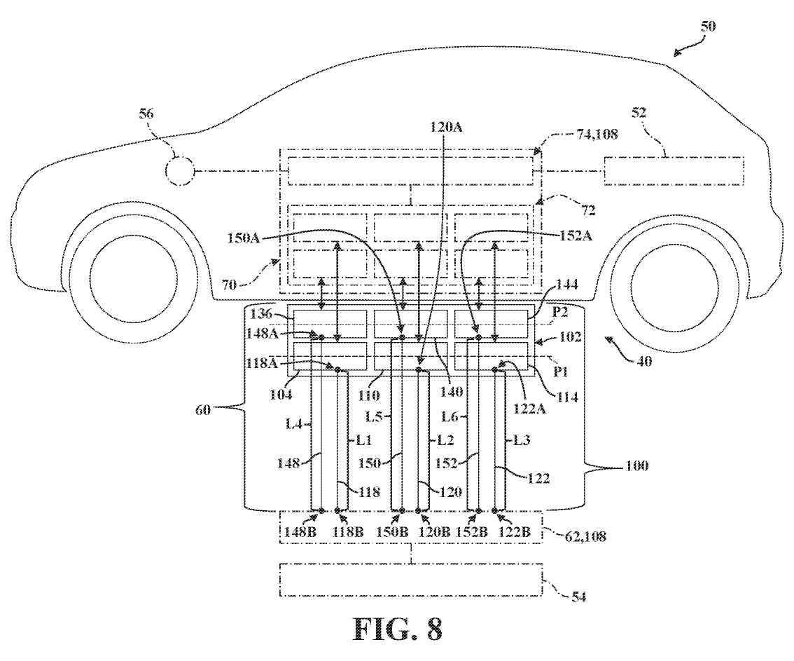

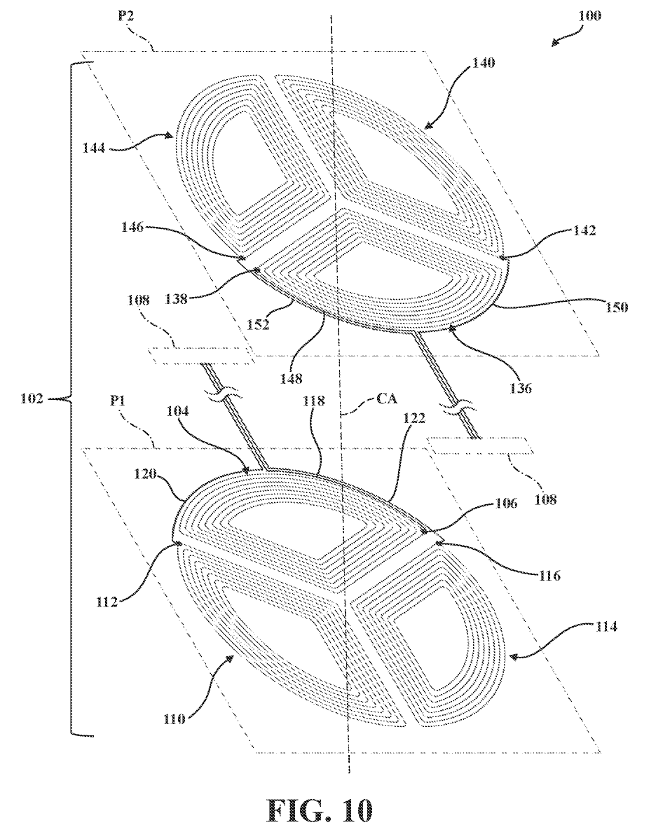

In some examples, the poly-phase coil assembly 102 further includes additional coils for transmitting and/or receiving AC power. For example, referring to FIGS. 8-10, the poly-phase coil assembly 102 may include a fourth coil 136 for transmitting and/or receiving AC power. The fourth coil 136 includes a fourth connection point 138 for coupling the fourth coil 136 to the power electronics unit 108. The poly-phase coil assembly 102 may also include a fifth coil 140 for transmitting and/or receiving AC power. The fifth coil 140 includes a fifth connection point 142 for coupling the fifth coil 140 to the power electronics unit 108. The poly-phase coil assembly 102 may further include a sixth coil 144 for transmitting and/or receiving AC power. The sixth coil 144 includes a sixth connection point 146 for coupling the sixth coil 144 to the power electronics unit 108. As described above, each of the first coil 104, the second coil 110, and the third coil 114 are typically coplanar with a first plane P1. As best shown in the schematic exploded view of FIG. 10, the fourth coil 136, the fifth coil 140, and the sixth coil 144 may be coplanar with a second plane P2 axially spaced from the first plane P1 along the central axis CA. Other configurations of disposing the fourth coil 136, the fifth coil 140, and the sixth coil 144 relative to the first coil 104, the second coil 110, and the third coil 114 are contemplated.

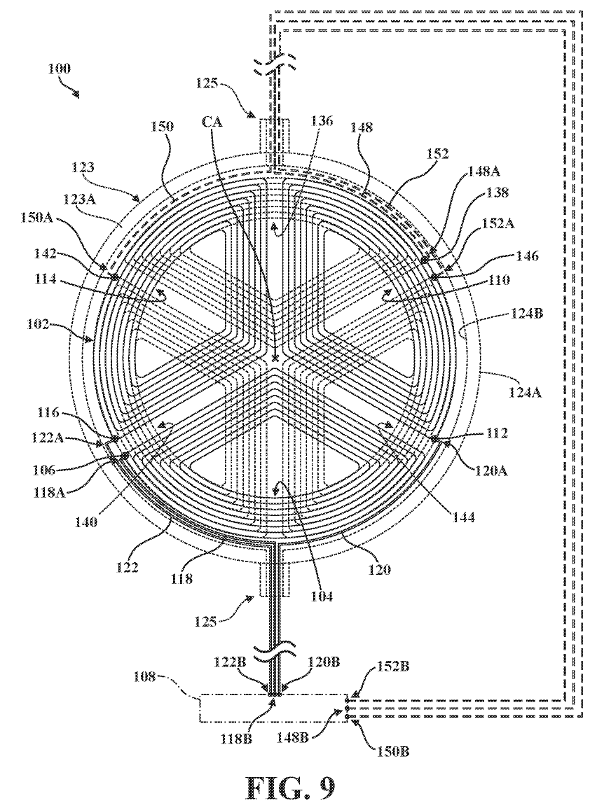

The fourth coil 136, the fifth coil 140, and/or the sixth coil 144 may have the same or similar configuration to the first coil 104, the second coil 110, and the third coil 114 as described above. For example, as schematically illustrated in FIGS. 9 and 10, the fourth coil 136, the fifth coil 140, and the sixth coil 144 may have identical structure to the first coil 104, the second coil 110, and the third coil 114, as described above. Other structural configurations of the fourth coil 136, the fifth coil 140, and/or the sixth coil 144 are contemplated. Additionally, the fourth connection point 138, the fifth connection point 142, and the sixth connection point 146 may have the same or similar configuration to the first connection point 106, the second connection point 112, and the third connection point 116, as described above. Other structural configurations of the fourth connection point 138, the fifth connection point 142, and the sixth connection point 146 are contemplated.

As best shown schematically in FIG. 8, the poly-phase inductive power transfer apparatus 100 may further include a fourth lead 148 for coupling the fourth coil 136 to the power electronics unit 108, a fifth lead 150 for coupling the fifth coil 140 to the power electronics unit 108, and a sixth lead 152 for coupling the sixth coil 144 to the power electronics unit 108. The fourth lead 148 extends between a fourth connection end 148A and a fourth coupling end 148B opposite the fourth connection end 148A. The fourth connection end 148A of the fourth lead 148 is coupled to the fourth coil 136 at the fourth connection point 138. For example, the fourth connection end 148A of the fourth lead 148 may be soldered or otherwise electrically coupled to the fourth connection point 138 of the fourth coil 136. The fourth coupling end 148B of the fourth lead 148 is configured to be coupled to the power electronics unit 108 such that the fourth lead 148 arranges the power electronics unit 108 in electrical communication with the fourth coil 136. The fourth lead 148 defines a fourth length L4 between the fourth connection end 148A and the fourth coupling end 148B. The fifth lead 150 extends between a fifth connection end 150A and a fifth coupling end 150B opposite the fifth connection end 150A. The fifth connection end 150A of the fifth lead 150 is coupled to the fifth coil 140 at the fifth connection point 142. The fifth coupling end 150B of the fifth lead 150 is configured to be coupled to the power electronics unit 108 such that the fifth lead 150 arranges the power electronics unit 108 in electrical communication with the fifth coil 140. The fifth lead 150 defines a fifth length L5 between the fifth connection end 150A and the fifth coupling end 150B. The sixth lead 152 extends between a sixth connection end 152A and a sixth coupling end 152B opposite the sixth connection end 152A. The sixth connection end 152A of the sixth lead 152 is coupled to the sixth coil 144 at the sixth connection point 146. The sixth coupling end 152B of the sixth lead 152 is configured to be coupled to the power electronics unit 108 such that the sixth lead 152 arranges the power electronics unit 108 in electrical communication with the sixth coil 144. The sixth lead 152 defines a sixth length L6 between the sixth connection end 152A and the sixth coupling end 152B.

Similar to as described above, the fourth length L4, the fifth length L5, and the sixth length L6 are substantially equal to reduce electromagnetic imbalance between the fourth coil 136, the fifth coil 140, and the sixth coil 144. In some configurations the fourth length L4, the fifth length L5, and the sixth length L6 may also be substantially equal to the first length L1, the second length L2, and the third length L3. The fourth lead 148, the fifth lead 150, and the sixth lead 152 may be routed from the poly-phase coil assembly 102 to the power electronics unit 108 in a similar manner as described above in the context of the first lead 118, second lead 120, and third lead 122. Other configurations of routing the fourth lead 148, the fifth lead 150, and the sixth lead 152 are contemplated.

In some examples, the fourth coil 136, the fifth coil 140, and/or the sixth coil 144 are configured to transmit and/or receive phases of AC power corresponding to the first coil 104, the second coil 110, and the third coil 114 in conjunction with the first coil 104, the second coil 110, and the third coil 114. For example, the fourth coil 136 may be configured to transmit and/or receive the first phase of AC power in conjunction with the first coil 104. In some examples, the fourth coil 136 may be electrically coupled to the power electronics unit 108 in parallel with the first coil 104. In other examples, the fourth coil 136 may be electrically coupled to the power electronics unit 108 in series with the first coil 104. In the configuration illustrated in FIG. 9, the fourth coil 136 is arranged opposite the first coil 104 across the central axis CA, but other arrangements are contemplated.

Similarly, the fifth coil 140 may be configured to transmit and/or receive the second phase of AC power in conjunction with the second coil 110. In some examples, the fifth coil 140 is electrically coupled to the power electronics unit 108 in parallel with the second coil 110. In other examples, the fifth coil 140 is electrically coupled to the power electronics unit 108 in series with the second coil 110. In the configuration illustrated in FIG. 9, the fifth coil 140 is arranged opposite the second coil 110 across the central axis CA, but other arrangements are contemplated.

Furthermore, the sixth coil 144 may be configured to transmit and/or receive the third phase of AC power in conjunction with the third coil 114. In some examples, the sixth coil 144 is electrically coupled to the power electronics unit 108 in parallel with the third coil 114. In other examples, the sixth coil 144 is electrically coupled to the power electronics unit 108 in series with the third coil 114. In the configuration illustrated in FIG. 9, the sixth coil 144 is arranged opposite the third coil 114 across the central axis CA, but other arrangements are contemplated.

It should also be appreciated that in other configurations, the fourth coil 136, the fifth coil 140, and/or the sixth coil 144 may be configured to transmit and/or receive independent phases of AC power. In other words, the fourth coil 136 may be configured to transmit and/or receive a fourth phase of AC power, the fifth coil 140 may be configured to transmit and/or receive a fifth phase of AC power, and the sixth coil 144 may be configured to transmit and/or receive a sixth phase of AC power. Other configurations of the poly-phase coil assembly 102 including additional coils for transmitting and/or receiving AC power are contemplated.

Several embodiments have been described in the foregoing description. However, the embodiments described herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

Various additional alterations and changes beyond those already mentioned herein can be made to the above-described embodiments. This disclosure is presented for illustrative purposes and should not be interpreted as an exhaustive description of all embodiments or to limit the scope of the claims to the specific elements illustrated or described in connection with these embodiments. For example, and without limitation, any individual element(s) of the described embodiments may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Any reference to claim elements in the singular, for example, using the articles “a,” “an,” “the” or “said,” is not to be construed as limiting the element to the singular. It will be further appreciated that the terms “include,” “includes,” and “including” have the same meaning as the terms “comprise,” “comprises,” and “comprising.”

What is claimed is:

1. A poly-phase inductive power transfer apparatus comprising:
a poly-phase coil assembly defining a central axis and comprising:
a first coil for transmitting and/or receiving a first phase of AC power, said first coil including a first connection point for coupling said first coil to a power electronics unit;
a second coil for transmitting and/or receiving a second phase of AC power, said second coil including a second connection point for coupling said second coil to the power electronics unit; and
a third coil for transmitting and/or receiving a third phase of AC power, said third coil including a third connection point for coupling said third coil to the power electronics unit;
a first lead extending between a first connection end coupled to said first coil at said first connection point and a first coupling end opposite said first connection end and configured to be coupled to the power electronics unit, said first lead defining a first length between said first connection end and said first coupling end;
a second lead extending between a second connection end coupled to said second coil at said second connection point and a second coupling end opposite said second connection end and configured to be coupled to the power electronics unit, said second lead defining a second length between said second connection end and said second coupling end; and
a third lead extending between a third connection end coupled to said third coil at said third connection point and a third coupling end opposite said third connection end and configured to be coupled to the power electronics unit, said third lead defining a third length between said third connection end and said third coupling end;
wherein said first length, said second length, and said third length are substantially equal to reduce electromagnetic imbalance between said first coil, said second coil, and said third coil.

2. The poly-phase inductive power transfer apparatus according to claim 1, wherein each of said first coil, said second coil, and said third coil comprise an arc portion extending circumferentially about said central axis between a first arc end and a second arc end, a first radial portion extending radially inward from said first arc end toward said central axis, and a second radial portion extending radially inward from said second arc end toward said central axis.

3. The poly-phase inductive power transfer apparatus according to claim 2,
wherein said first connection point is arranged at one of said first arc end and said second arc end of said first coil;
wherein said second connection point is arranged at one of said first arc end and said second arc end of said second coil; and
wherein said third connection point is arranged at one of said first arc end and said second arc end of said third coil.

4. The poly-phase inductive power transfer apparatus according to claim 3, wherein each of said first coil, said second coil, and said third coil have identical structure.

5. The poly-phase inductive power transfer apparatus according to claim 4,
wherein each of said first coil, said second coil, and said third coil define a first major face and a second major face opposite said first major face;
wherein said first major face of said first coil and said second coil faces a first axial direction along said central axis; and
wherein said second major face of said third coil faces said first axial direction along said central axis.

6. The poly-phase inductive power transfer apparatus according to claim 1 further comprising a housing defining a cylindrical housing interior concentric with said central axis;
wherein said first coil occupies a first sector of said cylindrical housing interior;
wherein said second coil occupies a second sector of said cylindrical housing interior;
wherein said third coil occupies a third sector of said cylindrical housing interior; and
wherein said first sector, said second sector, and said third sector are equal angular sectors of said cylindrical housing interior.

7. The poly-phase inductive power transfer apparatus according to claim 6,
wherein said housing defines a connection port through which each of said first lead, said second lead, and said third lead are disposed; and
wherein first connection point, said second connection point, and said third connection point are each arranged adjacent to an inner diameter of said cylindrical housing interior and spaced substantially equally from said connection port.

8. The poly-phase inductive power transfer apparatus according to claim 7, wherein each of said first coil, said second coil, and said third coil have identical structure.

9. The poly-phase inductive power transfer apparatus according to claim 1, wherein each of said first connection point, said second connection point, and said third connection point are equally radially spaced from said central axis.

10. The poly-phase inductive power transfer apparatus according to claim 9, wherein each of said first lead, said second lead, and said third lead are routed radially inward toward said central axis.

11. The poly-phase inductive power transfer apparatus according to claim 1, wherein each of said first coil, said second coil, and said third coil have identical structure.

12. The poly-phase inductive power transfer apparatus according to claim 11,
wherein each of said first coil, said second coil, and said third coil define a first major face and a second major face opposite said first major face;
wherein said first major face of said first coil and said second coil faces a first axial direction along said central axis; and
wherein said second major face of said third coil faces said first axial direction along said central axis.

13. The poly-phase inductive power transfer apparatus according to claim 1 further comprising a housing including a housing body defining a housing exterior and a housing interior;
wherein said first lead, said second lead, and said third lead each extend from said housing interior and through said housing body to said housing exterior.

14. The poly-phase inductive power transfer apparatus according to claim 1,
wherein said first lead comprises a first pair of lead wires coupled to said first coil and configured to be coupled to the power electronics unit;
wherein said second lead comprises a second pair of lead wires coupled to said second coil and configured to be coupled to the power electronics unit; and
wherein said third lead comprises a third pair of lead wires coupled to said third coil and configured to be coupled to the power electronics unit.

15. The poly-phase inductive power transfer apparatus according to claim 1, wherein each of said first coil, said second coil, and said third coil are coplanar with a first plane.

16. The poly-phase inductive power transfer apparatus according to claim 15,
wherein said poly-phase coil assembly further comprises:
a fourth coil for transmitting and/or receiving AC power, said fourth coil including a fourth connection point for coupling said fourth coil to the power electronics unit;
a fifth coil for transmitting and/or receiving AC power, said fifth coil including a fifth connection point for coupling said fifth coil to the power electronics unit; and
a sixth coil for transmitting and/or receiving AC power, said sixth coil including a sixth connection point for coupling said sixth coil to the power electronics unit; and
wherein each of said fourth coil, said fifth coil, and said sixth coil are coplanar with a second plane axially spaced from said first plane along said central axis.

17. The poly-phase inductive power transfer apparatus according to claim 16 further comprising:
a fourth lead extending between a fourth connection end coupled to said fourth coil at said fourth connection point and a fourth coupling end opposite said fourth connection end and configured to be coupled to the power electronics unit, said fourth lead defining a fourth length between said fourth connection end and said fourth coupling end;
a fifth lead extending between a fifth connection end coupled to said fifth coil at said fifth connection point and a fifth coupling end opposite said fifth connection end and configured to be coupled to the power electronics unit, said fifth lead defining a fifth length between said fifth connection end and said fifth coupling end; and
a sixth lead extending between a sixth connection end coupled to said sixth coil at said sixth connection point and a sixth coupling end opposite said sixth connection end and configured to be coupled to the power electronics unit, said sixth lead defining a sixth length between said sixth connection end and said sixth coupling end;
wherein said fourth length, said fifth length, and said sixth length are substantially equal to reduce electromagnetic imbalance between said fourth coil, said fifth coil, and said sixth coil.

18. The poly-phase inductive power transfer apparatus according to claim 16, wherein each of said first coil, said second coil, and third coil, said fourth coil, said fifth coil, and said sixth coil have identical structure.
